(19) United States
(12) Patent Application Publication
(10) Pub. No.: US 2016/0072693 A1
(43) Pub. Date: Mar. 10, 2016

(54) CLIENT-SERVER COMMUNICATION EVALUATION AND DIAGNOSTIC TOOL

(71) Applicant: Avaya Inc., Santa Clara, CA (US)

(72) Inventor: Paul Roller Michaelis, Louisville, CO (US)

(21) Appl. No.: 14/481,684

(22) Filed: Sep. 9, 2014

(51) Int. Cl. H04L 12/26; H04L 29/06

(52) U.S. Cl. CPC H04L 43/50; H04L 67/42; H04L 43/06

(57) ABSTRACT

A diagnostic system is described for use in analyzing client-server communications and, more specifically, communication applications that employ client-server interactions. The diagnostic system includes a client-side diagnostic tool and a server-side diagnostic tool that work in cooperation to analyze both sides of the client-server interaction for potential problems with the communication applications.

### FIELD OF THE DISCLOSURE

The present disclosure is generally directed toward communications and more specifically diagnostic tools for communication systems that employ a client-server model.

### BACKGROUND

A trend is developing to deploy more components of a communication system, such as an enterprise communication system, into the cloud where groups of remote, redundant, and highly-available servers are enabled to perform the functions previously performed by on-site servers. The primary advantage to implementing communication systems in the cloud is that the customer does not have to directly purchase and/or maintain their own servers. Unfortunately, this transition to the cloud introduces many obstacles.

One such problem is the potential introduction of bugs/problems to multiple points in a communication path. Specifically, a user may experience a problem with their communication system and because some of the components are local and other components are hosted in the cloud, it becomes increasingly difficult for the user to troubleshoot the problem.

As a more specific example, assume that a communication implements a client-server model where a server is utilized to support at least some communication features on behalf of the client. When a problem arises with such a system, a user (or system administrator) has a difficult task ahead of them to find the source of the problem. In particular, the diagnosis of the problem involves not only the need to identify where in the system the problem resides but who is responsible for the component that is the source of the problem. Said another way, the cloud-based solutions typically utilize multiple components and most components usually have different administrators and customer support resources.

The problem is made more complex by the fact that cloud-based communication applications utilize a variety of Internet Protocol packet types. Some packets, such as those associated with data transmissions, are typically transmitted via Transmission Control Protocol (TCP) mechanisms. Other packets, such as those associated with voice transmissions, are typically transmitted via User Datagram Protocol (UDP) mechanisms. It is not uncommon for the different packet types to be routed between client and server via different routers and different firewalls. Another consideration is that it is common for certain packet types to be used only for client-to-server communication or for server-to-client communication. A simple illustrative example is that a communication client must be able to send to the server the packet types utilized for dialing (e.g., RFC-2833 packets), but the server will never need to send those packet types to the client.

Needless to say, there is a need to simplify the evaluation and diagnostics of cloud-based communication systems.

### SUMMARY

It is, therefore, one aspect of the present disclosure to provide a diagnostic tool that can be operated by users and is capable of identifying the point(s) of failure in a communication system when all of the packets types that the communication application server must send to the client are not received or accepted by the client, or when all of the packet types that the client must send to the server are not received or accepted by the server. Such a diagnostic tool enables the user to quickly diagnose and resolve problems in a cloud-based communication system not only by identifying the source of the problem but the entity responsible for the component that is the source of the problem.

In some embodiments, the diagnostic tool of the present disclosure is enabled to analyze multiple aspects of a communication system in an attempt to identify the source of a problem and the entity associated with the source of the problem. In some embodiments, the diagnostic tool is capable of detecting and reporting one or more of the following:

(1) The required license is not present on the server(s) providing the service to the client device;

(2) The required license is present on the server(s), but the client device has not been enabled to use the required license;

(3) The required ports are not open on the server(s);

(4) The required ports are not open on the client device;

(5) One or more of the packet types that must go from the client to the server are being blocked by a firewall or gateway (often because of security concerns); and

(6) One or more of the packet types that must go from the server to the client are being blocked by a firewall or gateway (again, often because of security concerns).

Basic port scanning software can send out a request to connect to a target computer and determine which ports are open and responding. Ping is an IP network tool used to determine if a host is reachable. There are also a plethora of port testing tools that may determine what ports are available. These are commonly used for application/development testing. Unfortunately, these tools do not take into account the specific port and communication requirements for any particular application. Because of these limitations, basic port scanning software is not a suitable diagnostic tool, at least not by itself.

Antivirus tools also provide some ability to look for available devices and available ports on those devices, the idea being that these ports can be “back doors” for malicious code. While these antivirus tools are able to look for open ports, they are not configured to analyze packet transportability and license availability. Moreover, these antivirus tools are not able to check for open ports on the client device. Because of these shortcomings, basic modifications to antivirus tools are insufficient to diagnose problems in a cloud-based communication system.

Embodiments of the present disclosure provide a much more useful diagnostic tool. In some embodiments, the tool comprises a component that operates on the client side as well as a component that operates on the server side. For client-server applications that are to be assessed/analyzed (e.g., Avaya one-X Agent®, Avaya Communicator®, non-Avaya messaging services, etc.), the client-based component of the diagnostic tool would have information regarding the following prior to initiating connectivity tests:

(1) The servers that support the applications

(2) The ports that must be open on the client

(3) The licenses that must be available on the client and available to the user who is running the tool

(4) The packet types the client must be able to send successfully to the server, and

(5) The packet types the client must be able to receive from the server.

Such information could be made known to the client-based component of the diagnostic tool either programmatically or via a database lookup.

Analogously, for client-server applications of interest, the server-based component of the diagnostic tool would have information regarding the following:

(1) The ports that must be open on the server

(2) The licenses that must be available on the server and available to the user who is running the tool

(3) The packet types the server must be able to send successfully to the client, and

(4) The packet types the server must be able to receive from the client.

This information may be made available to the server-based component of the diagnostic tool programmatically, via a lookup table, or the like. In some embodiments, the connectivity testing could be initiated by the user (e.g., in response to the user experiencing problems with the communication system). Ideally, starting the tool on the user's client device (e.g., PC, tablet, telephone, SIP user agent, etc.) would trigger both the client and the server components to begin the appropriate sequence of diagnostic operations. In some embodiments, if a Local Area Network (LAN)-based connection between a client and server does not permit the client's “start” command to be received by the server, an alternate communication mechanism, such as a telephone-based Interactive Voice Response (IVR) application, could be used. Said another way, if the packet-based network is unavailable to carry the “start” command from the client to the server, then the “start” command could be re-routed over a different network (e.g., the Public Switched Telephone Network (PSTN) or the like).

On both the client and server, the availability of the required ports and licenses can be assessed. This assessment may be followed by test transmissions for all required packet types for which ports have been determined to be open. The server may be configured to send a first set of test packets whereas the client may be configured to send a second set of test packets during this assessment. Packets in the first and second sets of packets may have some test packets in common, but are not necessarily coextensive. In other words, some members of the first set of test packets may not belong to the second set of test packets or vice versa. The server(s) would provide feedback to the client tool regarding license and port availability in addition to information regarding which of the expected packets that had been transmitted by the client device had been received and which were not.

Because the diagnostic tool “knows” all of the information listed previously for all client-server applications of interest, the diagnostic tool is able to report a wide variety of information to the user. Illustratively, the diagnostic tool could yield a report to the user something like the following:

(1) You will be able to use communication application ABC.

(2) You will not be able to use communication application XYZ because no license has been assigned to you.

(3) If you use communication application ABC, voice functions will work properly. In addition, you will be able to receive TTY communication, but will not be able to send it because the RFC-4103 packets that the server was expecting to receive from your device were not delivered by the network.

In some embodiments, the diagnostic tool would provide advice and recommended solutions if certain applications are determined to be unusable. For example, “Although the current network configuration will not allow you to use the communication application ABC TTY adjunct when operating the application in a first mode, TTY communication would be supported if you operate communication application ABC in a second mode.”

In another embodiment, a user who needs access to a specific application that is not communicating correctly could ask the diagnostic tool to (e.g., automatically) send a diagnostic report and repair request to the appropriate system administrator(s). For example, if a deaf person cannot use the TTY adjunct on communication application MNO because no license is available AND because a network firewall does not permit the passage of the specialized RFC-4103 packets, the diagnostic tool could send a message to the administrator of a first application server saying “User John Smith needs a license for communication application MNO” and a separate message to the network administrator saying “The network between the PC used by John Smith and the first application server must permit the passage of specialized RFC-4103 packets.”

In some embodiments, a diagnostic system is provided that generally comprises:

a client-side diagnostic tool configured to execute a client-side diagnostic process that includes:
generating a first test packet;
determining a target server for the first test packet;
transmitting the first test packet to the target server;
waiting for a response to the first test packet; and
based on whether a response to the first test packet is received or not received,
   determining at least one of the following:
      a. if no response to the first test packet is received, determining that a firewall between the client device and server is a potential source of a communication problem between a client device and the server;
      b. if no response to the first test packet is received, determining that a port of the server associated with the first test packet is a potential source of a communication problem between the client device and the server; and
      c. if a response to the first test packet is received, determining that neither the port nor the firewall corresponds to a potential source of a communication problem between the client device and the server; and

a server-side diagnostic tool configured to execute a server-side diagnostic process that includes:

generating a second test packet;

transmitting the second test packet toward the client device from the port;

waiting for a response to the second test packet; and

based on whether a response to the second test packet is received or not received, determining whether the port corresponds to a potential source of a communication problem between the client and the server.

In some embodiments, the above process would repeat until all of the communication application's packet types that must be transmittable from the client to the server, and all of the packet types that must be transmittable from the server to the client, have been tested.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be a graph database as described herein. Accordingly, the disclosure is considered to include a tangible storage medium and prior art-recognized equivalents and successor media, in which the software implementations of the present disclosure are stored.

The terms “determine”, “calculate”, and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that individual aspects of the disclosure can be separately claimed.

### BRIEF DESCRIPTION OF THE DRAWINGS

The present disclosure is described in conjunction with the appended figures:

FIG. 1 is block diagram depicting a communication system in accordance with embodiments of the present disclosure;

FIG. 2 is a block diagram depicting details of a second communication system in accordance with embodiments of the present disclosure;

FIG. 3 is a block diagram depicting a server and components thereof in accordance with embodiments of the present disclosure;

FIG. 4 is a flow diagram depicting executable process performed by a client device and server(s) in connection with running a diagnostic process in accordance with embodiments of the present disclosure;

FIG. 5 is a flow diagram depicting a method of running a diagnostics process in accordance with embodiments of the present disclosure;

FIG. 6 is a flow diagram depicting a method of finalizing a diagnostics process in accordance with embodiments of the present disclosure;

FIG. 7 is a flow diagram depicting a method of analyzing license information in a communication system in accordance with embodiments of the present disclosure;

FIG. 8 is a flow diagram a method of port testing in accordance with embodiments of the present disclosure; and

FIG. 9 is a flow diagram depicting a method of sending test packets as part of a diagnostics process in accordance with at least some embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

It should be appreciated that embodiments of the present disclosure can be utilized in numerous environments where clients are having trouble establishing two-way communication with servers. Indeed, the types of problems described herein may appear whenever dedicated, sometimes proprietary, clients are installed in a Local Area Network (LAN)/Wide Area Network (WAN) and communicate with a server, specialized client/server applications, e.g., multimedia applications, collaboration tools, communication tools/applications, etc., and the like. Illustratively a connectivity problem unrelated to telecommunication might be expected to occur when a LAN-connected photocopy machines requires dedicated ports and proprietary protocols to communicate with an image/Optical Character Recognition (OCR) server. The diagnostic tool of the present disclosure could allow end-users to perform the appropriate diagnostics.

For a plurality of client-server applications, with known client-server connectivity requirements, the proposed diagnostic tool could:

(1) Determine port availability on the client and on the server;

(2) Determine license availability on the client and on the server; and/or

(3) Determine the packet types that are passed and the types that are blocked by firewalls and gateways.

In addition to determining the above information, the diagnostic tool of the present disclosure could be configured to:

(1) Inform an end-user which of the client-server applications that had been assessed by the diagnostic tool are supported and operable with no intervention by individuals other than the end-user (e.g., system administrators, network administrators, firewall administrators, and gateway administrators); and/or

(2) When an assessed application is determined to have no ability to operate (e.g., if the required license is not available) or only partial ability to operate (e.g., if some media types, but not all, are blocked by a firewall), then (a) provide diagnostic information and suggestions to the user, and/or (b) send a message automatically to the person or people who have control over the identified point-of-failure (e.g., system administrators, network administrators, firewall administrators, and gateway administrators).

Additional features and functions of the proposed diagnostic tool will be further understood with reference to the attached figures.

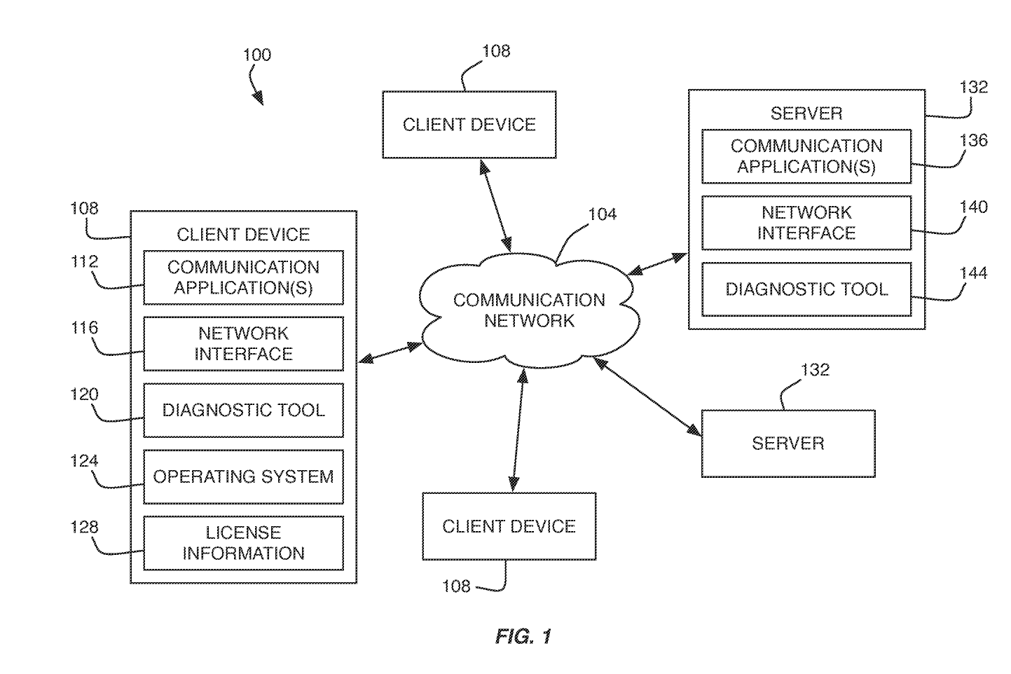

FIG. 1 shows an illustrative embodiment of a first communication system 100 in accordance with at least some embodiments of the present disclosure. The communication system 100 may be a distributed system and, in some embodiments, comprises a communication network 104 connecting components of a cloud-based communication system. In some embodiments, the communication system 100 comprises one or more client devices 108 connected to or connectable with one or more servers 132 via the communication network.

In accordance with at least some embodiments of the present disclosure, the communication network 104 may comprise any type of known communication medium or collection of communication media and may use any type of protocols to transport messages between endpoints. The communication network 104 may include wired and/or wireless communication technologies. The Internet is an example of the communication network 104 that constitutes and Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a LAN, a WAN, a Session Initiation Protocol (SIP) network, a Voice over IP (VoIP) network, a cellular network, and any other type of packet-switched or circuit-switched network known in the art. In addition, it can be appreciated that the communication network 104 need not be limited to any one network type, and instead may be comprised of a number of different networks and/or network types. Moreover, the communication network 104 may comprise a number of different communication media such as coaxial cable, copper cable/wire, fiber-optic cable, antennas for transmitting/receiving wireless messages, and combinations thereof.

The client devices 108 may correspond to communication endpoints or user devices and may be configured for use by one or multiple users. Client devices 108 configured for use by multiple users may be referred to as shared client devices.

A client device 108 may correspond to one or multiple communication endpoints utilized by a user to facilitate communications with the server 132 and/or other client devices 108. In some embodiments, a client device 108 may include, without limitation, a telephone, a softphone, a cellular phone, a multi-speaker communication device (e.g., conference phone), a video phone, a PC, a laptop, a tablet, a PDA, a smartphone, a thin client, or the like. It should be appreciated that a client device 108 may be configured to support single or multi-user interactions with other client devices 108 within an enterprise communication network and/or across multiple communication networks.

As depicting in FIG. 1, the client device 108 may comprise one or more communication applications 112, one or more network interfaces 116, a diagnostic tool 120 (e.g., a client-side component of a diagnostic tool), one or more operating systems 124, and license information 128. The communication application(s) 112 may enable the client device 108 to participate in communication sessions with other client devices 108. Examples of communication applications 112 include, without limitation, voice applications, video applications, SMS applications, email applications, adjuncts, multi-media communication applications, collaboration applications, web browsers, and the like. The communication application(s) 112 may correspond to dedicated applications or they may be incorporated into the operation system 124 of the client device 108.

The network interface(s) 116 of the client device 116 may correspond to the hardware and/or drivers that are used by the client device 108 to connect with and communicate over the communication network 104. Examples of network interfaces 116 include, without limitation, Wi-Fi ports, Ethernet ports, antennas, Network Interface Cards (NICs), drivers for the same, and the like. The network interface(s) 116 may be operated by drivers under the control of the operating system 124.

The diagnostic tool 120 may correspond to the client-side component of the diagnostic tool that is used to evaluate communication abilities of the client device 108. Moreover, as will be discussed herein, the diagnostic tool 120 may provide the mechanism for generating reports, displaying feedback to a user of the client device 108, and the like. The diagnostic tool 120 may also be configured to initiate an overall diagnostic process in response to receiving a request from the client device 108. Specifically, a user of the client device 108 may provide an input to the client device 108 that initiates the diagnostic tool 120 to begin a diagnostic process on the client device 108 and whichever servers 132 are being used to support the communication applications(s) 112 or communication features during a communication session. As a more specific example, the diagnostic tool 120 may provide an instruction to a diagnostic tool 144 on a server 132 that is designed to support communications for the communication application(s) 112 on the client device 108 or that is currently providing communication features to the client device 108 during a communication session.

The operating system 124 may correspond to a traditional operating system executed on a PC or the like or a mobile operating system. The operating system 124 may be executed by one or more microprocessors of the client device 108 or it may be executed in a virtual machine. Examples of an operating system 124 include, without limitation, Android, BSD, iOS, Linux, OS X, QNX, Microsoft Windows, Windows Phone, and IBM z/OS. The operating system 124 is a general-purpose application that enables access to and utilization of multiple other applications on the client device 108. Moreover, the operating system 124 may provide the interface between hardware of the client device 108 (e.g., user input, user output, processors, memory, network interface(s) 116, etc.) and the various applications 112 stored on the client device 108.

The license information 128 may correspond to licenses or information describing licenses for the use of the operating system 124 and/or communication applications 112 on the client device 108. In some embodiments, the license information 128 may actually be stored within the application 112, 124 to which it provides a license for use. In other embodiments, the license information 128 may be stored separate from the application to which it provides a license for use. The license information 128 may be stored in an encrypted or unencrypted state.

The client device 108 may utilize the resources of the server(s) 132 before, during, and/or after a communication session with other client devices. More specifically, when one client device 108 is involved in a communication session with at least one other client device 108, one or both client devices 108 may utilize one or more resources from the servers(s) 132 to obtain enhanced features for the communication session. As a non-limiting example, the server(s) 132 may include a communication application(s) 136 that provides one or more features to the client device(s) 108 before, during, or after a communication session. Examples of communication application(s) 136 include, without limitation, an EC-500 (extension to cellular) application, a call-setup application, a call-recording application, a caller ID application, a dynamic device pairing application, a voicemail application, an email application, a voice application, a video application, a text application, a conferencing application, a communication log service, a security application, an encryption application, a collaboration application, a whiteboard application, mobility applications, presence applications, media applications, messaging applications, bridging applications, a text-to-speech application, a speech-to-text application, a TTY application, and any other type of application that can supplement or enhance communications between client devices 108.

In some embodiments, the server(s) 132 may correspond to one or multiple servers (e.g., a server cluster) that are used to help establish communication sessions, sequence applications, enable communication preferences for users, enforce communication restrictions on users, etc. Specifically, the server(s) 132 may include a Private Branch eXchange (PBX), an enterprise switch, an enterprise server, combinations thereof, or any other type of telecommunications system switch or server. The server(s) 132 is, in some embodiments, can be configured to execute telecommunication functions such as the suite of Avaya Aura™ applications of Avaya, Inc., including Communication Manager™, Avaya Aura Communication Manager™, Avaya IP Office™, Communication Manager Branch™, Session Manager™, System Manager™, MultiVantage Express™, and combinations thereof.

FIG. 1 also shows the server 132 as comprising one or more network interfaces 140 and a diagnostic tool 144 (e.g., a server-side component of the diagnostic tool). The network interface(s) 140 of the server 132 may include one or multiple Ethernet ports, data ports, drivers for the same, or the like. In some embodiments, the network interface 140 may comprise multiple registered ports or ephemeral ports. As an example, the server 132 may comprise one or more ports having a port number in the range from 0 to 1023 which correspond the well-known ports or system ports, which may or may not be assigned a specific function by the Internet Assigned Numbers Authority (IRNA). As another example, one or more of the ports may be assigned a number in the range between 49152-65535 (above the registered ports), in which case they correspond to dynamic or private ports that cannot be registered with IRNA.

The diagnostic tool 144 on the server 132 may correspond to a complimentary component of the diagnostic tool 120 on the client device 108. Together the components 120, 144 may correspond to a diagnostic tool that is capable of analyzing the collective behavior of the client device 108 and server(s) 132 to troubleshoot communication capabilities or the lack thereof. More specifically, the diagnostic tools 120, 144 may be capable of assessing operating conditions of the device on which they are stored, license information, port availability, packet transmission, connectivity, and the like to determine source(s) and/or entities associated with source(s) of devices that are frustrating a client-server relationship and communication capabilities desired from the client-server relationship.

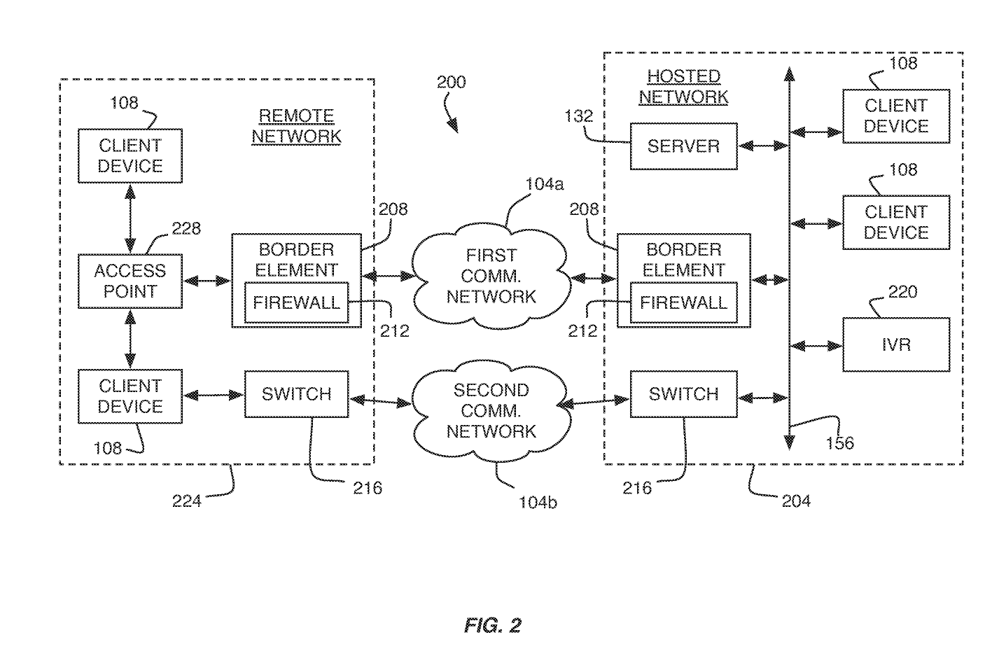

With reference now to FIG. 2, additional details of a second communication system 200, which may correspond to a specific version of the first communication system 100, will be described in accordance with at least some embodiments of the present disclosure. The communication system 200 depicts one or more client devices 108 situated in a hosted network 204 as well as one or more client devices 108 situated in a remote network 108. The hosted network 204 may correspond to an enterprise network, trusted network, or the like that also contains one or more servers 132. The client devices 108 and server 132 in the hosted network 204 may be connected by a trusted network 156 in the form of a LAN, WAN, Virtual Private Network (VPN), or the like. The hosted network 204 may also comprise a border element 208, a switch 216, and an Interactive Voice Response (IVR) unit 220.

In some embodiments, the border element 208 may comprise a firewall 212 or the like that helps to maintain the security and trust within the hosted network 204. Specifically, the border element 208 may comprise a Session Border Controller (SBC), a gateway, a Network Address Translator (NAT) device, or some other network element that resides between the trusted network 156 and a first untrusted communication network 104a (e.g., the Internet or some other packet-based communication network).

The switch 216 may correspond to a second device in the hosted network 204 that separates the trusted network 156 from an external network, such as a second communication network 104b (e.g., the PSTN or some other circuit-switched network). The switch 216 may correspond to a single switch or a plurality of switches. The switch 216 may also provide protocol conversions between the second communication network 104b and the trusted network 156.

The remote network 224 is referred to as a remote network since the remote network 224 does not have a locally-hosted server 132. It should be appreciated that a client device 108 does not necessarily have to belong to any network (hosted, remote, or otherwise). Instead, a client device 108 may be connected directly to a communication network 104 via a modem, network access point (e.g., wired or wireless access point), or the like.

Similar to the hosted network 204, the remote network 224 may also comprise a border element 208 with a firewall 212, a switch 216, and the like. In some embodiments, instead of having a trusted network 156, the remote network 224 may comprise an access point 228 such as a router (wired or wireless) or the like that provides connectivity between the border element 208 of the remote network 224 and the client devices 108. It should also be appreciated that the functionality of the border element 208 and switch 216 may be implemented in a single device.

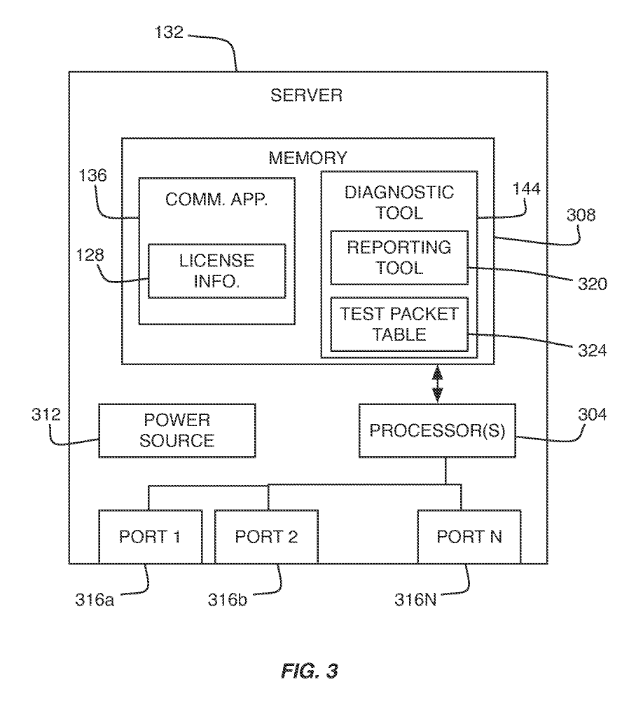

FIG. 3 depicts additional details of an illustrative server 132. It should be appreciated that a server 132 may comprise some or all of the components depicted in the server 132 of FIG. 3. In the depicted embodiment, the server 132 comprises one or more processors (e.g., microprocessors, parallel processors, Integrated Circuit (IC) chips, etc.), memory 308, a power source 312, and one or more ports 316a-N.

In some embodiments, the memory 308 may include any type of non-transitory computer-readable medium or a collection of computer-readable media. The memory 308 may be volatile, non-volatile, or virtual. Examples of memory 308 include, without limitation, flash memory, ROM/PROM/EPROM/EEPROM memory, firmware, RAM, DRAM, SRAM, cache memory, buffer memory, combinations thereof, or the like. In the depicted embodiment, the memory 308 stores instructions that are executable by the processor(s) 304. Examples of the instructions or data that may be stored in memory 308 include the communication application 136 and the diagnostic tool 144.

As mentioned above, the license information 128 may be included in the communication application 136. The diagnostic tool 144 may include a reporting tool 320 that is used to generate and provide a diagnostic report on behalf of the diagnostic tool 144 to a user and/or a system administrator. The diagnostic tool 144 may also include a test packet table 324 or some other data structure that enables the diagnostic tool 144 to have a priori knowledge (e.g., knowledge prior to the initiation of a diagnostics process) of the types of test packets that should be transmitted when an instruction to begin a diagnostic process is received at the server 132. In other words, the test packet table 324 may provide the diagnostic tool 144 with the information needed to generate a set of test packets, where each packet in the set of test packets is of a certain type and is used for testing a particular port 316a-N. It should be appreciated that the information from the test packet table 324 may be made available programmatically to the diagnostic tool 144 instead of being contained in a table 324 structure.

Although only the diagnostic tool 144 on the server 132 is depicted as having a reporting tool 320 and test packet table 324, it should be appreciated that the diagnostic tool 120 on the client device 108 may also or alternatively have a reporting tool 320 and/or test packet table 324. The reporting tool 320 may generate one or more diagnostic reports that identify a source of a failure during a communication session, communication capabilities of a client device 108 before a communication session, and/or a source of a failure after a communication session has ended. The reporting tool 320 may provide the report or portions thereof to interested parties (e.g., participants to a communication session, a system administrator, an administrator of a particular component involved in the client-server relationship, etc.) in the form of an email, an attachment to an email, an SMS message, a text message, a printed report, a notification, a flashing light, an alarm, or the like.

The power source 312 may correspond to an internal power source (e.g., a battery or collection of batteries) and/or to an energy-conversion device (e.g., a transformer, power adapter, power conditioner, etc.). The power source 312 may provide the server 132 with sufficient power to enable the functionality of the processor(s) 304 and the other components in the server 132 that require power to operate.

The ports 316a-N correspond to specific examples of the network interface 140 that may be included in a server 132. While three ports are depicted, it should be appreciated that a server 132 may comprise a greater or lesser number of ports. Each port may correspond to an actual physical port (e.g., with hardware adapters and drivers) or to a virtual port. Furthermore, each port 316 may be assigned a particular function and, therefore, may be utilized to receive packets of a certain type. The diagnostic tool 144 may be made aware of the various ports 316a-N in the server and the function of the ports 316a-N. Knowledge of such information can assist in the diagnostic tool 144 in identifying potential sources of problems in a client-server relationship and, in some embodiments, may help the diagnostic tool 144 know which types of test packets to send to the client 108 (e.g., because the server 132 has a corresponding port) and which types of test packets are not needed for diagnostic purposes (e.g., because the server 132 does not have a corresponding port).

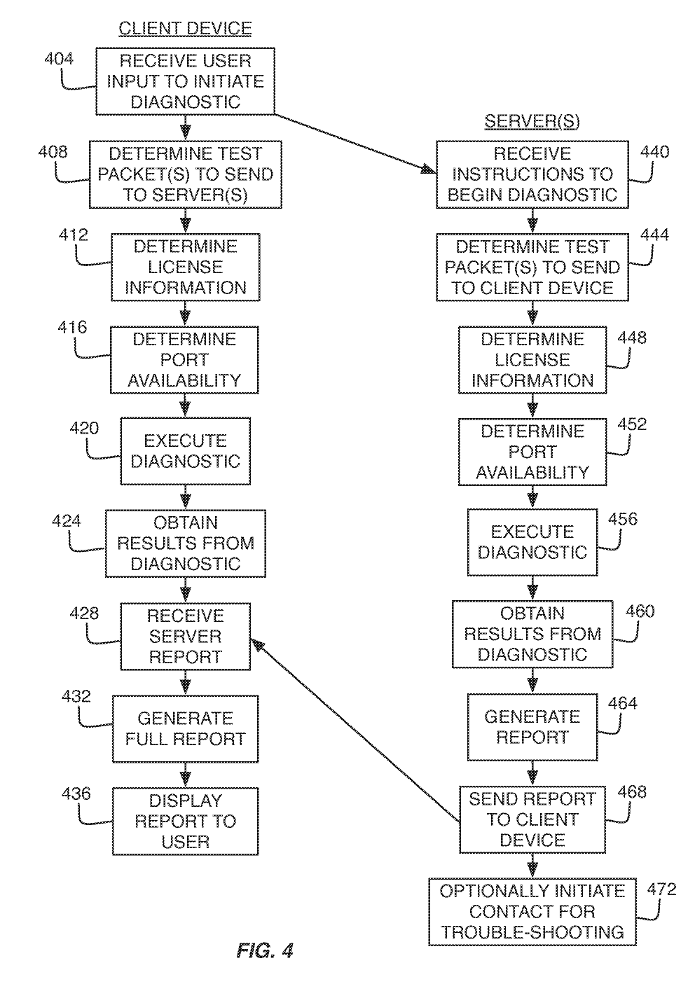

With reference now to FIG. 4, a diagnostic process will be described in accordance with at least some embodiments of the present disclosure. The diagnostic process begins with the client device 108 receiving a user input that initiates the diagnostic process (step 404). In another embodiment, the diagnostic process may be automatically initiated in response to the expiration of a timer (e.g., due to a routine diagnostic process being desired), the occurrence of a predetermined event, or any other event that can automatically trigger the initiation of the diagnostic process. The manual initiation of the diagnostic process may be received at the client device 108 and specifically the diagnostic tool 120 on the client device 108 whereas the automatic initiation of the diagnostic process may occur at either diagnostic tool 120, 144. If the initial instruction from the diagnostic tool 120 to the diagnostic tool 144 is returned to the client device 108 as undeliverable (e.g., due to a network failure, connection failure, etc.), the diagnostic tool 120 may determine that the first communication network 104a is unavailable and may attempt to transmit a second initiation instruction to the diagnostic tool 144 via the second communication network 104b. Specifically, if the user of the client device 108 has voice capabilities and can connect with an IVR 220 of the hosted network 204, then it can be surmised that the second communication network 104b is at least capable of carrying data from the client device 108 into the hosted network 204. This may also provide information to the diagnostic tool 120 that source of communication problems resides either in the first communication network 104a or at one of the border elements 208 in the networks 204, 224.

The diagnostic process continues with the client device 108 sending an instruction to the server(s) 132 involved in the client-server communication to begin server-side diagnostics (step 440). On the client side, the diagnostic tool 120 begins its portion of the diagnostic process by identifying which types of packets to send and which servers to send the packets towards (step 408). Specifically, the diagnostic tool 120 may determine the server(s) 132 that it will need to communicate with to obtain desired communication features. This information may be pre-programmed into the diagnostic tool 120 or the diagnostic tool 120 may run a routine whereby a user of the client device 108 is queried about the types of communication capabilities that are desired for a communication session or multiple communication sessions. Packet types may also be defined by the types of media utilized by a communication application 112, 136, the types of call features made available by such communication applications 112, 136, the types of data required to support call features made available by the communication applications 112, 136, etc.

In addition to determining the types of test packet(s) to send to the server(s) 132, the diagnostic tool 120 also determines license information 128 available on the client device 108. More specifically, the diagnostic tool 120 may determine whether certain communication applications 112 have a corresponding license and, if not, what types of licenses are required to enable such communication applications 112.

The diagnostic tool 120 continues the diagnostic process by determining port availability for the server(s) 132 that it identified in step 408 (step 412) and executing its overall diagnostic routine (step 420). Specifically, the diagnostic tool 120 may transmit the test packet(s) to the determined server(s) 132 and wait for a response. Such a process is known as “pinging” the server(s) with the determined test packets. If all of the transmitted test packets are confirmed as being received by the server(s) 132, then the diagnostic tool 120 can determine that the necessary ports 316a-N are available to the server(s) 132. On the other hand, if one or more of the test packets is not confirmed as being received by the target server(s) 132, then the diagnostic tool 120 can determine that the port corresponding to the missing test packet is not available, closed, dedicated to another communication session, etc. If none of the test packets are confirmed as being received by the target server(s) 132, then the diagnostic tool 120 may determine that there is a connectivity problem either on the first communication network 104a or at some communication component residing between the client device 108 and server 132. For instance, a firewall 212 at either the hosted network 204, the remote network 224, or some other intermediary network therebetween may be blocking some or all of the packets (including test packets) transmitted between the client device 108 and target server(s) 132.

Based on the information obtained from the execution of the diagnostic routine in step 420, the diagnostic tool 120 is able to obtain diagnostic results (step 424) with respect to the client-side of the system. A full diagnostic report, however, will also benefit from server-side diagnostics performed by the diagnostic tool 144.

Accordingly, the server-side diagnostics may be performed serially or sequentially with respect to the client-side diagnostics. When the diagnostic tool 144 of the server 132 receives the triggering instruction from the diagnostic tool 120 of the client device 108, the diagnostic tool 144 determines which types of test packets to send to the client device 108 (step 444). Much like step 408, this step may involve the diagnostic tool 144 identifying the types of communication features desired, the media desired, etc. In some embodiments, the diagnostic tool 144 may determine this information in isolation from the diagnostic tool 120. In some embodiments, the diagnostic tool 120 may instruct the diagnostic tool 144 as to the types of test packets that are required for the diagnostic process.

In addition to determining the types of test packet(s) to send to the client device 108, the diagnostic tool 144 also determines license information 128 available on the server 132 (step 448). This particular step may involve analyzing the various licenses 128 stored in memory 308, analyzing particular licenses 128 stored in a communication application 136, and/or analyzing the licenses otherwise granted for the communication applications 136 of the server 132.

The diagnostic tool 144 continues the diagnostic process by determining port availability from its own perspective (step 452) and executing its overall diagnostic routine (step 456). In particular, the diagnostic tool 144 may attempt to transmit its test packet(s) to the client device 108 via each of the assigned ports 316a-N, depending upon the type of test packet being transmitted. If the port reports itself as being unavailable or there is no response to a particular test packet, then the corresponding port 316a-N may be determined to be a potential source of the communication problem.

The results of the overall diagnostic routine are then gathered at the diagnostic tool 144 (step 460) and a server-side report is generated based on such information (step 464). The diagnostic tool 144 may then transmit its server-side diagnostic report to the diagnostic tool 120 on the client 108 (steps 468, 428) such that the diagnostic tool 120 has both the client-side and server-side information about the diagnostic report. In some embodiments, it may be desirable to gather the client-side report and server-side report at the diagnostic tool 144 of the server 132 instead of the client device 108. In other words, embodiments of the present disclosure should not be construed as limiting the invention to the illustrative embodiment of FIG. 4. At the end of its diagnostic process, the server may optionally generate and transmit a contact to an appropriate administrator for troubleshooting (step 472). This step may only be required if the server 132 determined that one or more potential sources of a problem were associated with the server 132. In other words, if the server 132 determines that it is at least one source of a communication problem (e.g., due to port issues, license issues, etc.), then the server 132 may directly contact a system administrator for that server 132 to troubleshoot the problem.

The diagnostic tool 120 at the client 108 may also send this report to a system administrator for the server(s) 132 identified as potential problem sources. In some embodiments, because the diagnostic tool 120 is collecting both client-side and server-side information, the diagnostic tool 120 can generate a full diagnostic report (step 432) and transmit it to the entities that administer or own the potential source of a problem. Alternatively or additionally, the diagnostic tool 120 may display some or all of the full diagnostic report to the user of the client device 108 via a user output (e.g., screen) of the client device 108 or by printing a physical report on a printer or the like (step 436). This enables the user and/or appropriate system administrators to immediately have access to the same diagnostic report that includes both client-side diagnostics as well as server-side diagnostics.

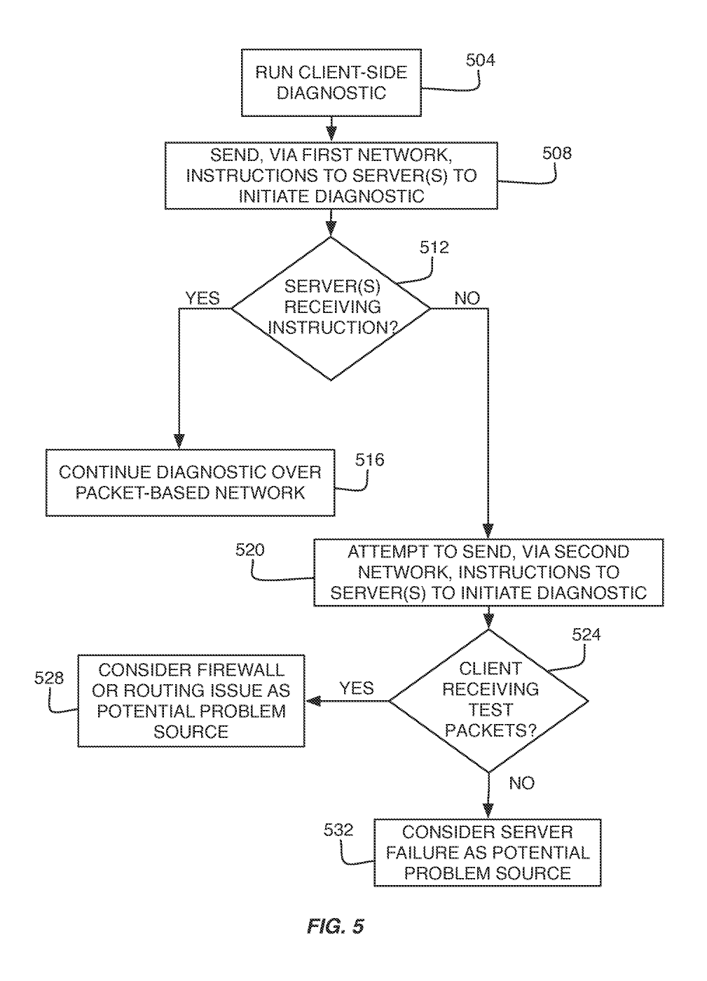

With reference now to FIG. 5, additional details of running a diagnostics routine at the diagnostic tool 120 of the client device 108 will be described in accordance with at least some embodiments of the present disclosure. The method begins at step 504 and continues with the diagnostic tool 120 attempting to send instructions to one or more server 132 to initiate a diagnostic routine (step 508). In some embodiments, the diagnostic tool 120 initially attempts to send the instructions via the first communication network 104a (e.g., a packet-based network, such as the Internet).

The diagnostic tool 120 then waits to see if the server(s) 132 acknowledge receipt of the instruction(s) (step 512). If the target server(s) 132 acknowledge receipt of the instruction(s), then the diagnostic tool 120 will continue running its diagnostic routine over the first communication network 104a (step 516).

On the other hand, if there is no indication that the server(s) 132 received the instruction from the diagnostic tool 120, then the diagnostic tool 120 will attempt to send the instructions to the server(s) 132 again, but this time via a second communication network 104b (e.g., a circuit-switched network) (step 520). Following transmission of this second instruction, the diagnostic tool 120 may continue running its client-side diagnostic routine. Additionally, the diagnostic tool 120 will monitor its network interface 116 for test packets transmitted by the server(s) 132 that are also running their own diagnostic routine (step 524). If the diagnostic tool 120 does not receive any test packets, then the diagnostic tool 120 may consider that the server is a potential problem source (step 532). If the client device 108 does receive one or more test packets, then the diagnostic tool 120 may consider a firewall 212 and/or routing issues as at least one potential problem source (step 528). It may be difficult for the diagnostic tool 120 to determine whether the problem source is the firewall 212 at the hosted network 208 or a firewall at some other intermediary network. However, the diagnostic tool 120 may be configured to run additional diagnostic processes to determine if the firewall 212 is blocking one or more packets from reaching the target server 132, for example by sending additional packets of different types and/or containing different payloads to determine if any such packets reach the target server 132. It should be appreciated that if the client device 108 is within the same hosted network 204 as the target server 132, then it may be possible to eliminate the firewall 212 as a source of the potential problem in step 528.

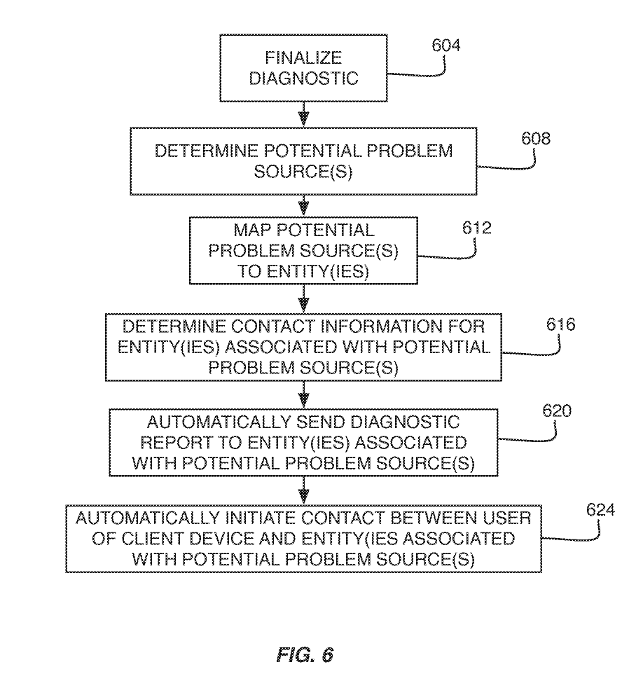

With reference now to FIG. 6, additional details of finalizing a diagnostic process will be described in accordance with at least some embodiments of the present disclosure. It should be appreciated that this finalization can occur at the diagnostic tool 120, the diagnostic tool 144, or a combination thereof. The method begins at step 604 when the diagnostic tool 120, 144 has obtained the necessary reports from both the client-side and server-side diagnostic processes. Thereafter, the diagnostic tool 120, 144 determines the one or more sources of the potential problem based on the information contained in the diagnostic reports (step 608).

The diagnostic tool 120, 144 then maps the potential problem source(s) to one or more entities that are responsible for administering the potential problem source(s) and/or have a unique ability to either troubleshoot, provide troubleshooting information, or control the potential problem source(s) (step 612). In some embodiments, this information can be maintained in a table that maps components involved in a client-server communication to various entities. In other embodiments, a query may be sent to a high-level system administrator to determine an entity that is associated with a particular potential problem source.

After the one or more entities have been determined, the method continues by determining contact information for the one or more entities (step 616). The contact information can be in the form of an email address, phone number, help line, IM address, website, etc. The diagnostic tool 120, 144 may then send the diagnostic report (or portions pertinent to the entity) to the entity via the contact information (step 620). An additional and optional step may be performed whereby a contact is automatically escalated between a user of the client device 108 and the one or more entities identified in step 612 (step 624). For instance, if a user of the client device 108 is having problems with a communication application 112, and the potential source of the problem is determined to be a firewall issue 212 and a server 132 issue, then two distinct contacts can be automatically initiated between the user of the client device 108 and each entity responsible for the potential source of the problem. One of the automatic contacts can be real-time (e.g., a voice call) whereas another of the automatic contact can be non-real-time (e.g., email, chat, etc.). This enables the user to easily and efficiently start resolving their problem without having to independently identify the entities associated with the potential problems or identify contact information for the entities.

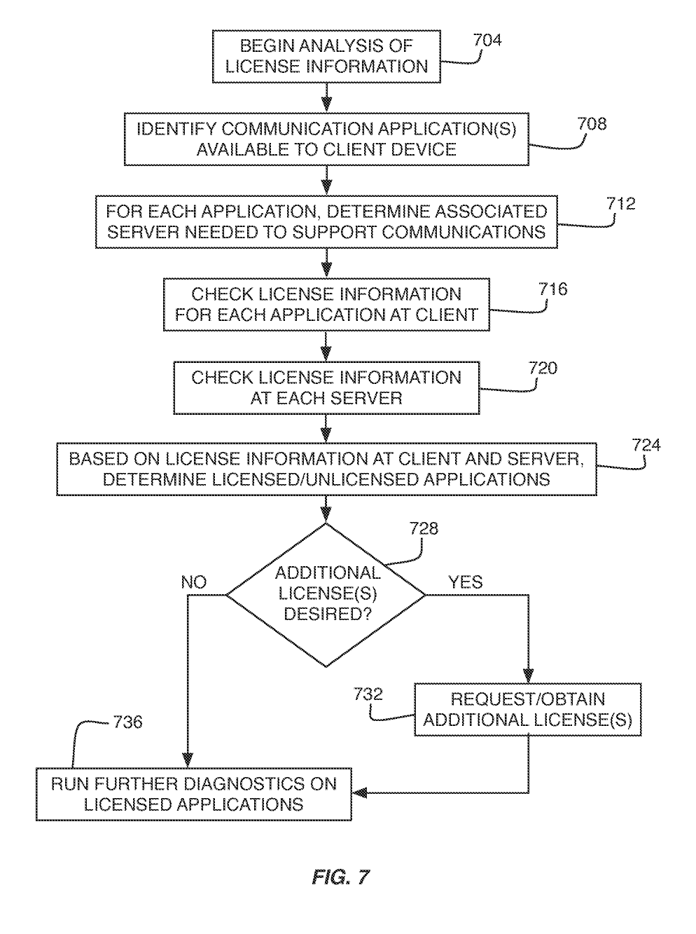

With reference now to FIG. 7, details of a method of analyzing license information will be described in accordance with at least some embodiments of the present disclosure. Much like FIG. 6, the diagnostic tool 120 on the client 108, the diagnostic tool 144 on the server 132, or a combination thereof may perform some or all of the steps described in FIG. 7.

The method begins with the diagnostic tool 120, 144 beginning the analysis of license information (step 704). This analysis may occur locally (e.g., for the license information on the same device as the analyzing diagnostic tool 120, 144) or remotely (e.g., where one diagnostic tool 120, 144 requests license information from another remote device).

As part of analyzing the license information, the communication application(s) 112 available to the client device 108 and/or utilized by the client device 108 for particular types of communication sessions are determined (step 708). For each application identified in step 708, it is determined which server(s) 132 are utilized to support communications via the communication application 112 (step 712). Before, thereafter, or simultaneous therewith, the diagnostic tool 120, 144 may check the license information for each application 112 on the client device 108 (step 716). In other embodiments, the diagnostic tool 120, 144 may check other devices to determine if the licenses for the communication applications 112 are stored somewhere other than on the client device 108. The diagnostic tool 120, 144 may also check the license information 18 at the server(s) 132 identified in step 712 (step 720). In some embodiments, the license information 128 for each communication application 136 on the server 132 used to support a communication application 112 on the client device 108 is analyzed.

Based on the analysis of the license information 128 at the client-side and server-side, the method continues by determining which applications 112, 136 are licensed and/or unlicensed (step 724). Lack of a license may be determined in response to an application having no license, an expired license, or an invalid (e.g., duplicate) license. If each and every application 112, 136 analyzed has a corresponding valid license, then the process is complete. Thus, the process continues by determining if additional licenses are desired (step 728). If this query is answered negatively, then no additional licenses are needed and the process continues with the diagnostic tools 120, 144 running additional diagnostics on the licensed applications (e.g., for issues other than license issues) (step 736). On the other hand, if there is at least one problem identified with a license on either the client device 108 or server 132, then the process continues by attempting to obtain the additional licenses (step 732). This is an optional step and may be performed by querhying the user of the client device 108 or a system administrator if additional licenses are desired. In other embodiments, the lack of the appropriate license(s) may simply be reported to a user and/or system administrator without necessarily suggesting the need to purchase additional licenses. The method then continues to step 736.

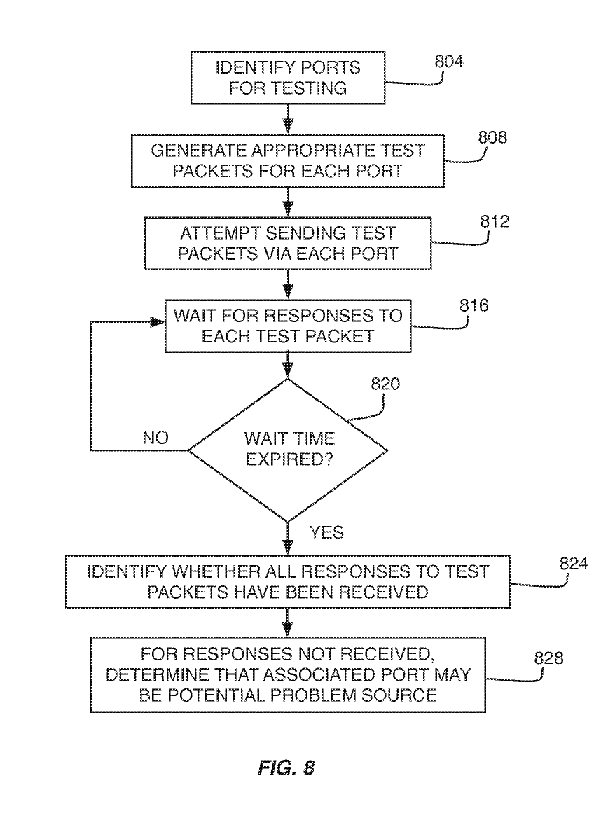

With reference now to FIG. 8, additional details of a method for testing port 316 availability will be described in accordance with at least some embodiments of the present disclosure. Again like FIGS. 6 and 7, the diagnostic tool 120 on the client 108, the diagnostic tool 144 on the server 132, or a combination thereof may perform some or all of the steps described in FIG. 8.

The method begins with the diagnostic tool 120, 144 initiating port testing (step 804) and for each port 316 to be tested generating an appropriate test packet (step 808). Since the server 132 may have ports 316 dedicated to particular functions or packet types, then analysis of a particular port 316 may require the use of a specific test packet (depending upon the assigned functionality of the port 316). The method continues with the diagnostic tool 120, 144 instructing its device (e.g., client device 108 or server 132) to attempt sending the test packets via each port (e.g., into or out of the associated port 316) (step 812). The diagnostic tool 120, 144 then waits to see if a response to the test packet (e.g., a confirmation of receipt) is received for the test packet(s) transmitted in step 812 (step 816). The diagnostic tool 120, 144 may wait for a predetermined amount of time to see if such a response is received (step 820).

If the timer has not expired, but the response to the test packet has not been received, then the diagnostic tool 120, 144 will continue to wait. Once the timer has expired, the diagnostic tool 120, 144 will determine whether responses have been received in connection with each transmitted test packet (step 824). For those test packets that did not receive a response, the diagnostic tool 120, 144 may determine that the port(s) 316 associated with the test packets corresponds to a potential problem source (step 828). It may also be possible to further troubleshoot the port(s) 316 identified in step 828 by attempting to send different packet types via the port(s) 316 and/or by monitoring the port activity for use by other applications.

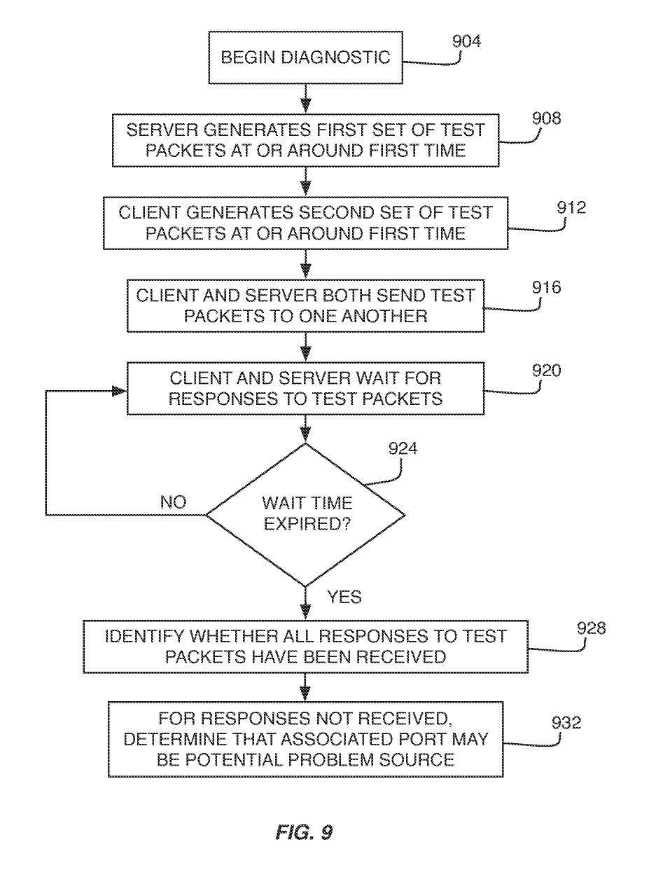

With reference now to FIG. 9, yet another diagnostics process will be described in accordance with at least some embodiments of the present disclosure. The process begins with the one of the diagnostic tools 120, 144 initiating the diagnostics process (step 904). In some embodiments, the diagnostic tool 120 initiates the process in response to receiving a request from a user of the client device 108 and then by transmitting an instruction to the server 132 to begin the process.

The process continues with the server 132 generating a first set of test packets at or around a first time (step 908). The first set of test packets may be determined, at least in part, based on information contained in the test packet table 324. Additionally, the first time may correspond to a time immediately following receipt and processing of an instruction from the client device 108 to begin the diagnostics process. In other words, the first time may correspond to a slightly delayed time relative to initial transmission of the instruction by the client device 108.

The process also has the client device 108 generate a second set of test packets at or around the same time that the server 132 generated its test packets (step 912). In some embodiments, the client device 108 may begin generating its set of test packets immediately following transmission of the initiation instruction to the server 132. In some embodiments, the client device 108 may wait until receipt of the instruction is confirmed by the server 132 (by waiting until a receive response is received at the client device 108). In some embodiments, the client device 108 may wait a predetermined amount of time following either transmission of the initiation instruction or receipt of a response from the server 132. In other words, it is beneficial to have the client device 108 and server 132 somewhat synchronized with respect to the generation and eventual transmission of their respective test packets. It is not required, however, to have strict adherence to absolute synchronization. A tolerance of seconds, tens of seconds, or even hundreds of seconds may be tolerated between generation and transmission by the client device 108 and server 132. It is generally not desirable, however, to have one component (e.g., the client device 108) generate and send its test packets at one time and then have the other component (e.g., the server 132) generate and sends its test packets at a substantially later time because it is beneficial to capture the nature of the problem from both the client device 108 and server 132 at around the same time to avoid having the problem go away or transform due to the transient nature of such network problems.

In some embodiments, the server 132 is configured to send at least one type of test packet that is not sent by the client device 108, or vice versa. In other words, the types of packets included in the first set of packets should not perfectly match the types of packets included in the second set of packets. This enables the server 132 to test one or more ports 316a-N that are not necessarily tested by the client device 108, or vice versa. This is also more representative of the natural behavior of a communication system 100 whereby the client device 108 will usually send some packets that the server 132 will not (e.g., packets for touch-tone signaling) or vice versa (e.g., RFC 2833 packets). It is useful to generate and send the types of packets normally sent by each component during operations.

The process continues with the client device 108 and server 132 both sending their respective test packets to one another (step 916). Again, it is preferable that the transmission of the test packets occur around (but not necessarily exactly at) the same time.

The respective devices then wait for responses to their test packets (step 920). If the wait time has yet to expire, then the devices continue waiting (step 924). After a predetermined wait time has expired or some other event has occurred, the process continues with each device identifying whether responses to their test packets have been received (step 928). Based on the information obtained at both sides of the system, the potentially problem sources (e.g., problem ports 316a-N) may be identified by the diagnostic tools 120, 144 (step 932).

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A communication system, comprising:
at least one server, comprising:
a network interface that includes one or more ports that facilitate communications between the at least one server and a communication network;
a processor; and
memory that comprises one or more communication applications being executable by the processor and utilizing the one or more ports to communicate with a client device in connection with executing the one or more communication applications, the memory further comprising a diagnostic tool that is also executable by the processor, wherein the diagnostic tool, when executed by the processor, performs a diagnostic process in response to a request from a client device, wherein the diagnostic process includes:
identifying a first communication application from the one or more communication applications to subject to the diagnostic process;
identifying a first set of test packets to transmit from the server to the client device, wherein test packets in the first set of test packets correspond to packets transmitted by the server to the client device during normal execution of the first communication application;
determining a port from the one or more ports that is associated with each test packet in the first set of test packets;
transmitting each test packet from the first set of test packets toward the client device;
waiting for one or more test packets from a second set of test packets that are expected at the server from the client device, wherein test packets in the second set of test packets correspond to packets transmitted by the client device to the server during normal execution of the first communication application, and wherein the first and second sets of test packets are not coextensive; and
generating a report for the first communication application based on whether or not the one or more packets from the second set of test packets are received at the server.

2. The communication system of claim 1, wherein the diagnostic process further includes:
determining that at least one packet from the second set of test packets is not received at the server;
in response to determining that the at least one packet from the second set of test packets is not received, determining that a port assigned to the missing at least one packet corresponds to a potential source of the communication problem between the client and the server; and
generating a diagnostic report that identifies the port as a potential source of the communication problem between the client and the server.

3. The communication system of claim 2, wherein the diagnostic process further includes:
mapping the server to an entity responsible for administration or control of the server;
determining contact information for the entity; and
including the contact information in the diagnostic report.

4. The communication system of claim 3, wherein the diagnostic tool automatically attempts to establish a communication session between a user of the client device and the entity.

5. The communication system of claim 1, wherein the memory includes a test packet table that provides the diagnostic tool with information about first set of packets and the second set of packets.

6. The communication system of claim 1, wherein the diagnostic process further includes:
determining that no responses to test packets transmitted by the server to the client device are being received at the server; and
determining that a firewall between the server and the client corresponds to a potential source of the communication problem between the client and the server.

7. The communication system of claim 1, wherein the diagnostic process further includes:
analyzing at least one license associated with the first communication application;
determining, based on the analysis of the at least one license, whether the first communication application is licensed for use with the client; and
including information regarding the at least one license in the diagnostic report.

8. A communication system, comprising:
a client device, comprising:
a network interface that facilitates communications between the client device and a communication network;
a processor; and
memory that comprises a communication applications, the communication application being executable by the processor and utilizing the network interface to communicate with a server in connection with executing the communication application, the memory further comprising a diagnostic tool that is also executable by the processor, wherein the diagnostic tool, when executed by the processor, transmits an instruction to the server to begin a server-side diagnostic process, and wherein the diagnostic tool, when executed by the processor, performs a client-side diagnostic process that includes:
identifying a first set of test packets to transmit from the client device to the server, wherein test packets in the first set of test packets correspond to packets transmitted by the client device to the server during normal execution of the communication application;
transmitting each test packet from the first set of test packets toward the server;
waiting for one or more test packets from a second set of test packets that are expected at the client device from the server, wherein test packets in the second set of test packets correspond to packets transmitted by the server to the client device during normal execution of the communication application, and wherein the first and second sets of test packets comprise at least one different type of test packet from one another;
receiving information regarding whether or not each packet in the first set of test packets were received by the server; and
generating a report for the communication application based on whether each packet in the second set of test packets is received at the client device and further based on whether each packet in the first set of test packets is received at the server.

9. The system of claim 8, wherein the first and second set of test packets are transmitted at or around a same time and wherein the test packets transmitted by the server toward the client device are transmitted via a predetermined port of the server based on a function assigned to the predetermined port.

10. The system of claim 8, wherein the client-side diagnostic process further comprises:
determining that the firewall corresponds to a potential source of a communication problem between the client device and server;
mapping the firewall to an entity responsible for administration or control of the firewall;
determining contact information for the entity; and
including the contact information in the report.

11. The system of claim 10, wherein the report includes information obtained based on the client-side diagnostic process and the server-side diagnostic process.

12. The system of claim 8, wherein the diagnostic tool is further configured to determine that the instruction transmitted to the server to begin the server-side diagnostic process was not received by the server and, in response thereto, transmit a second instruction to the server, wherein the second instruction is transmitted to the server via an alternative network.

13. The system of claim 8, wherein the instruction to initiate the server-side diagnostic process is transmitted in response to the client device receiving a user input indicating problems with a communication session between the client device and the server.

14. The server of claim 8, wherein the client-side diagnostic process further comprises:
analyzing at least one license associated with the communication application;
determining, based on the analysis of the at least one license, whether the communication application is licensed for use by the client; and
including information regarding the at least one license in the report.

15. A diagnostic system, comprising:
a client-side diagnostic tool configured to execute a client-side diagnostic process that includes:
identifying a communication application from one or more communication applications to subject to a diagnostic process;
identifying a first set of test packets to transmit from a client device to a server, wherein test packets in the first set of test packets correspond to packets transmitted by the client device to the server during normal execution of the communication application;
transmitting each test packet from the first set of test packets toward the server;
waiting for one or more test packets from a second set of test packets that are expected at the client device from the server, wherein test packets in the second set of test packets correspond to packets transmitted by the server to the client device during normal execution of the communication application, and wherein the first and second sets of test packets comprise at least one different type of test packet from one another;
receiving information regarding whether or not each packet in the first set of test packets were received by the server; and
generating a client-side report for the communication application based on whether each packet in the second set of test packets is received at the client device and further based on whether each packet in the first set of test packets is received at the server; and
a server-side diagnostic tool configured to execute a server-side diagnostic process that includes:
identifying the second set of test packets based on an indication of the communication application;
determining a port from the one or more ports that is associated with each test packet in the second set of test packets;
transmitting each test packet from the second set of test packets toward the client device;
waiting for one or more test packets from the first set of test packets that are expected at the server from the client device; and
generating a server-side report for the communication application based on whether or not the one or more packets from the first set of test packets are received at the server.

16. The diagnostic system of claim 15, wherein the server-side diagnostic process further includes:
determining that a response to at least one packet in the second set of test packets is not received at the server;
in response to determining that the response is not received, determining that the port corresponds to a potential source of the communication problem between the client and the server; and
generating a diagnostic report that identifies the port as a potential source of the communication problem between the client and the server.

17. The diagnostic system of claim 16, wherein a complete diagnostic report is generated with the client-side report and the server-side report and wherein the complete diagnostic report includes information obtained based on the client-side diagnostic process and the server-side diagnostic process.

18. The diagnostic system of claim 17, wherein the complete diagnostic report contains information obtained from both the client-side diagnostic tool and the server-side diagnostic tool.

19. The diagnostic system of claim 15, wherein the client-side diagnostic tool provides an instruction to the server-side diagnostic tool to initiate the server-side diagnostic process.

20. The diagnostic system of claim 15, wherein client-side diagnostic tool is configured to analyze license information on the client, wherein the server-side diagnostic tool is configured to analyze license information on the server, and wherein the license information analyzed on the client and the server corresponds to client and server licenses for the communication application that is resident on the client device and the server.
